(19) United States
(12) Patent Application Publication
(10) Pub. No.: US 2007/0107181 A1
(43) Pub. Date: May 17, 2007

(54) Datum transfer method and apparatus

(76) Inventors: James Marion Vau, Los Lunas, NM (US); Brett Wayne Byrnes, Tijeras, NM (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 11/270,093

(22) Filed: Nov. 9, 2005

(51) Int. Cl. B23Q 17/00

(52) U.S. Cl. 29/407.05; 269/86

(57) ABSTRACT

A method for locating a work piece for multiple treatment operations includes identifying six-point datum positions upon a work piece, defining six-point datum contacts on a work piece holder and securing said six-point datum positions upon said work piece into contact with said six-point datum contacts on said work piece holder. A work piece datum transfer apparatus includes a work piece shuttle having a six-point datum nest defining its position in three dimensions corresponding to a work piece six-point datum nest and means for locking said work piece shuttle into contact with said work piece shuttle to transfer said datum nest from said work piece to said shuttle.

### BACKGROUND OF THE INVENTION

This invention relates generally to the field of tooling and systems for precision metalworking operations, and more particularly, to a datum transfer system to facilitate multiple precision metalworking steps to be performed on a work piece.

Metalworking frequently involves precision machining of work pieces, often within tolerances of a few mils. (One mil is 0.001 of an inch, or 25 micrometers.) Essential prerequisites of precision machining include rigid support of the work piece and exact movement of the work piece during machining. In conventional metalworking practice, dedicated tooling to hold a particular work piece for each metalworking operation is provided. Such dedicated tooling must provide rigid support for the work piece.

A metalworking operation can involve the machining of families of work pieces of the same general, proportional shape, but different in size and dimensions. Typically, a family of dedicated holding devices is required for a family of work piece members. While some parts in a work piece family can be very small, and the assorted dedicated tooling can be manipulated and carried by hand, other work pieces and their dedicated tooling can be much larger, requiring mechanical assistance (e.g., a crane) to lift, carry and position the dedicated tooling devices.

Dedicated tooling is designed to hold one work piece family member in a precise location and position for a metalworking operation. The alignment of the dedicated tooling and the work piece it holds to the metalworking machine must be exact, and often requires significant setup time to ensure proper alignment with the metalworking machine. Achieving such alignment is a trial-and-error process, generally requiring repeating steps of tapping the tooling to move it a small distance, tightening the bolts used to secure it in place, and then checking the alignment using dial indicators or the like. The critical nature of this process typically requires attention by the most highly skilled workers in a manufacturing facility. Often, trial parts of the work piece must be test worked, with minute adjustments of the dedicated tooling to the worktable, to ensure the metalworking operation machines the work piece properly.

When a metalworking facility needs to machine a variety of members of a work piece family, there can be significant amounts of production time lost in tooling changeover, in disassembling tooling used on the first work piece, retrieving the dedicated tooling for the next work piece, and then installing and aligning the retrieved dedicated tooling for each work piece to be worked. Changing the tooling from that required for one work piece to that required for another similar work piece is frequently a major factor in the cost for operating a metalworking facility, particularly when business conditions in the industry can necessitate small production lot sizes.

In addition, to machine a family of work pieces that are similar in size but different in detail, equivalent families of dedicated tooling are often required to complete the manufacture. Because each set of dedicated tooling must accept and secure the work piece in generally two or more places for proper positioning and alignment, these dedicated tools can be complex and expensive.

### BRIEF DESCRIPTION OF THE INVENTION

One aspect of the present invention relates to an improved fixture for accurately positioning a work piece requiring precision machining, such as a turbine blade. A work piece support system includes locating a six-point datum on a work piece shuttle, locking supports for securing a work piece relative to the shuttle, and datum transfer arms for positioning the shuttle relative to a plurality of V-block work piece supports.

Another aspect of the invention is a method for locating a work piece for multiple treatment operations. A work piece is secured in a shuttle in a particular orientation with respect to a six-point datum nest on the shuttle, and locked into position by spring loaded work supports.

### BRIEF DESCRIPTION OF THE DRAWINGS

FIG. 1 is a schematic illustration of one embodiment of a work piece mounting shuttle for providing a six-point datum nest and a work piece to be secured;

FIG. 2 is a schematic illustration of a work piece having identified datum points for defining structure of the work piece for machining;

FIG. 3 is a schematic illustration of work piece positioning features of the embodiment of a work piece shuttle of FIG. 1;

FIGS. 4 and 5 are schematic illustrations of a holding fixture showing a work piece in position to be secured for machining;

FIG. 6 is a schematic illustration of a spring mounting assembly for maintaining a work piece in position during machining; and

FIGS. 7 and 8 are schematic illustrations of features of one clamp arrangement for securing a work piece in position for machining while clamped in the datum nest.

### DETAILED DESCRIPTION OF THE INVENTION

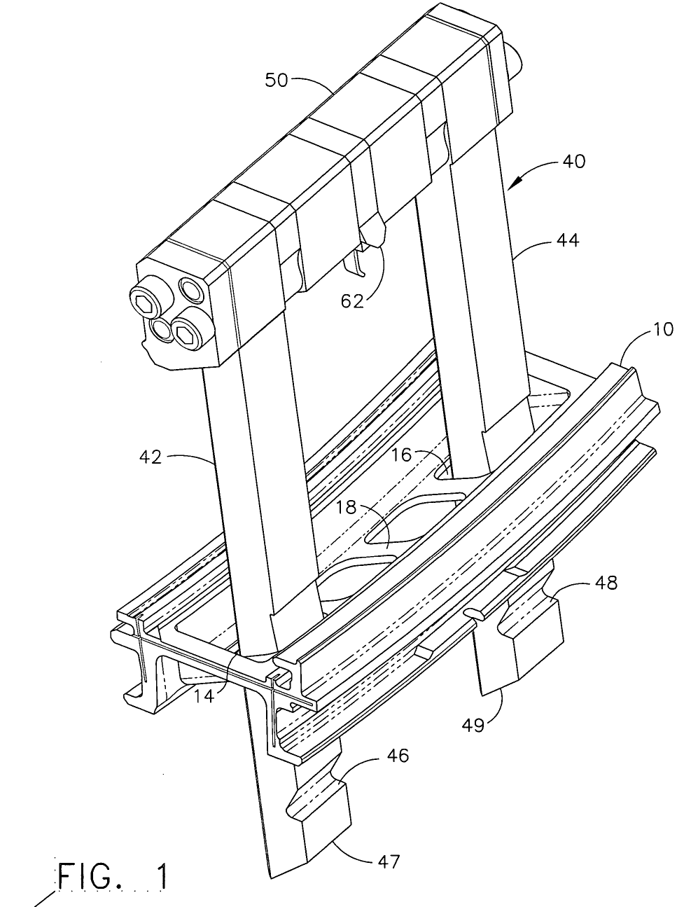

FIG. 1 is a schematic illustration of one embodiment of a work piece holder 40 aligned with a work piece 10 to be machined, polished, finished or treated by other manufacturing techniques. Work piece holder 40 includes shuttle 50 and a pair of transfer arms 42, 44 having respective notches 46, 48 for engagement by clamping and transfer mechanisms and locator surfaces 47, 49 at the ends of respective transfer arms 42, 44. The transfer arms 42, 44 extend through respective holes 14, 16 in a work piece ID pocket web 18 to engage the base (not shown) of a work piece holder.

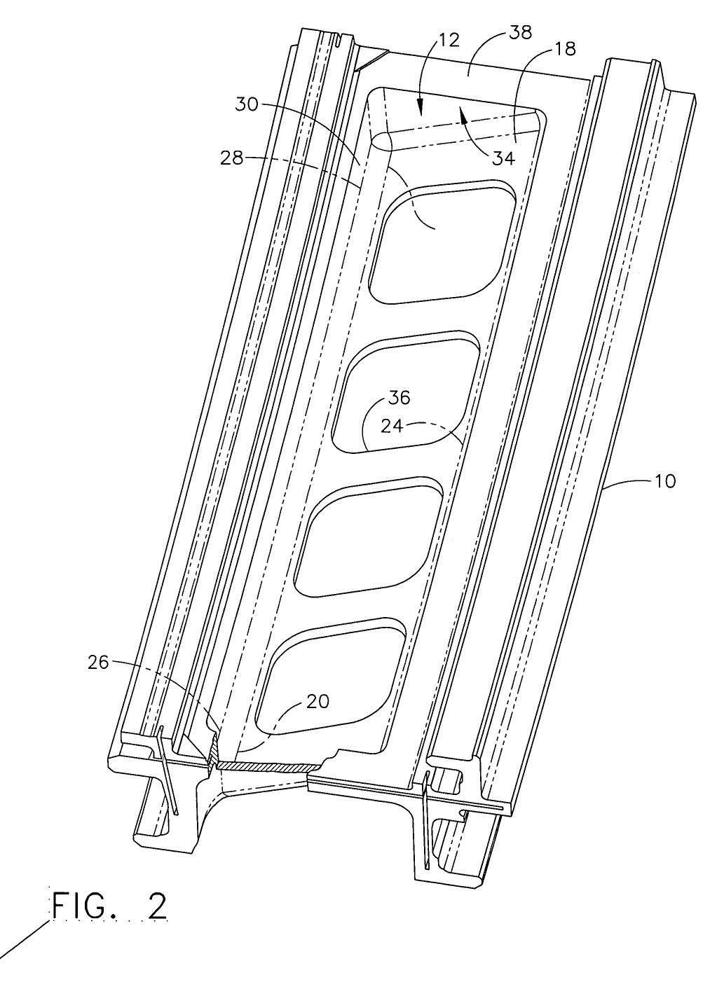

FIG. 2 is a schematic illustration of one embodiment of a work piece 10 having a six-point datum nest in an ID pocket 12 which includes a work piece six-point datum including datum positions 20, 22, 24, 26, 28 and 32 which together precisely define the work piece position in three dimensions in reference to a precision casting standard. ID pocket 10 includes ID pocket web 18 which contains datum positions 20, 22 and 24 which define a plane within work piece 10. Vertical wall 30 of the ID pocket 12 includes two work piece datum positions 26, 28 which define a line 32 through work piece 10, and end surface 38 of ID pocket 12 includes one datum position 34 of the cast work piece 10. ID pocket 12 is located in a portion of the work piece 10 that requires no machining or finishing following casting of the work piece 10. This allows a fixture to engage the work piece datum positions throughout all machining, finishing or other processes required to complete manufacturing of the work piece 10, so that a single step of positioning and locking work piece 10 into holding fixtures is needed, thereby reducing set-up time and opportunity for introduction of errors in the fixturing.

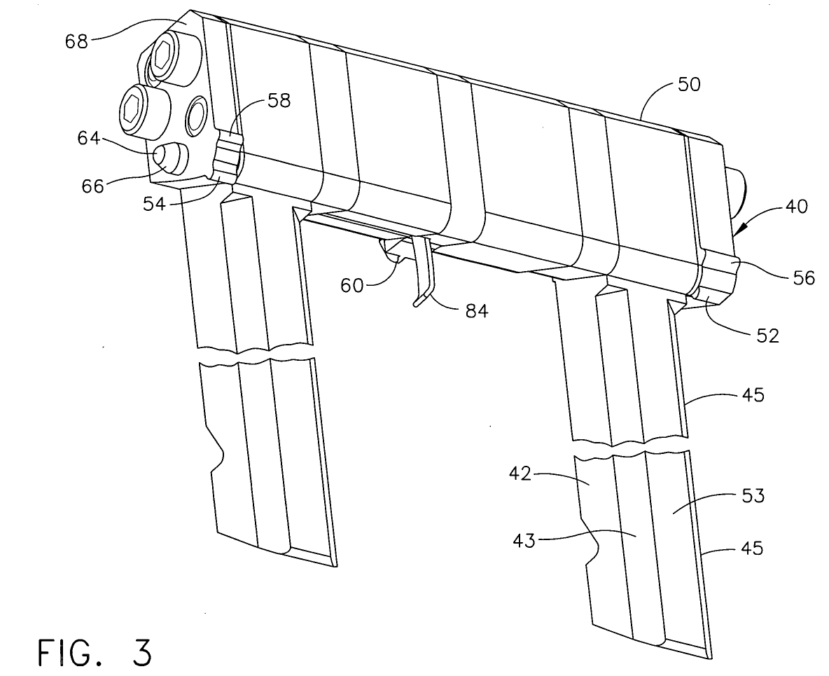

FIG. 3 is a schematic illustration of the work piece shuttle 50 which is designed and made to include datum contacts 52, 54, 56, 58, 60 and 64 which constitute a shuttle six-point datum nest which is a precise indicator of the position in three dimensions of work piece shuttle 50. The datum contacts 56, 58 are located to engage work piece datum positions 26, 28, respectively, datum contacts 52, 54 are located to engage work piece datum positions 20, 22, respectively, datum contact 60 on projection 62 is located to engage datum position 24 and datum contact 64 on pin 66 which projects from end 68 of work piece shuttle 50 is located to engage datum position 34. A tapered, spring-loaded lever 84 projects from the work piece shuttle 50 to contact end wall of one surface of hole 36 through ID pocket web 18. When the six-point work piece datum positions are in secure contact with the respective work piece datum positions, the location of the shuttle 50 precisely defines the location of work piece 10. Since the ID pocket 12 requires no machining or finishing, the work piece datum positions may be engaged throughout all machining and finishing of other surfaces. This avoids the possibility of introducing errors in machining or finishing the work piece due to variances in work piece holders.

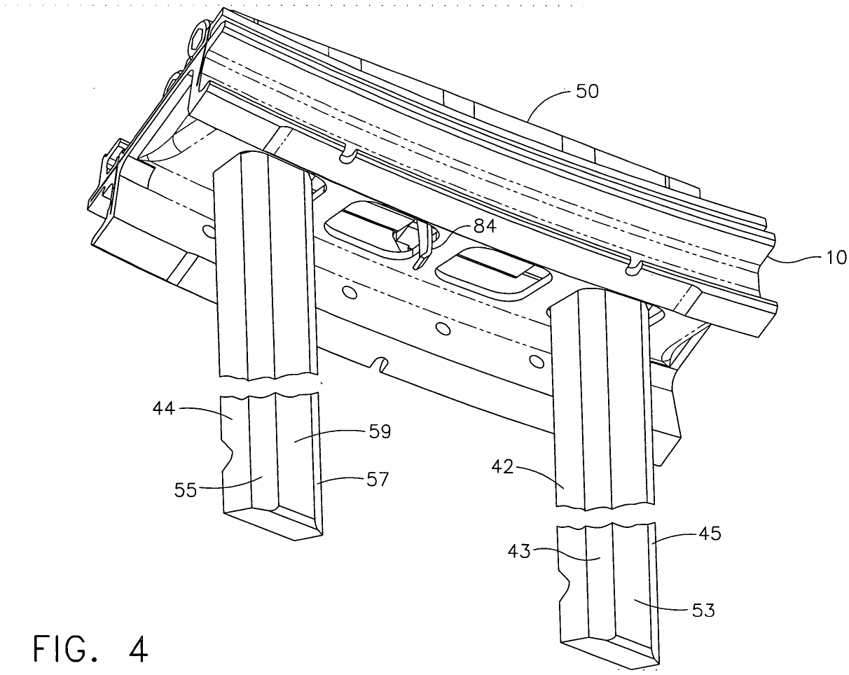

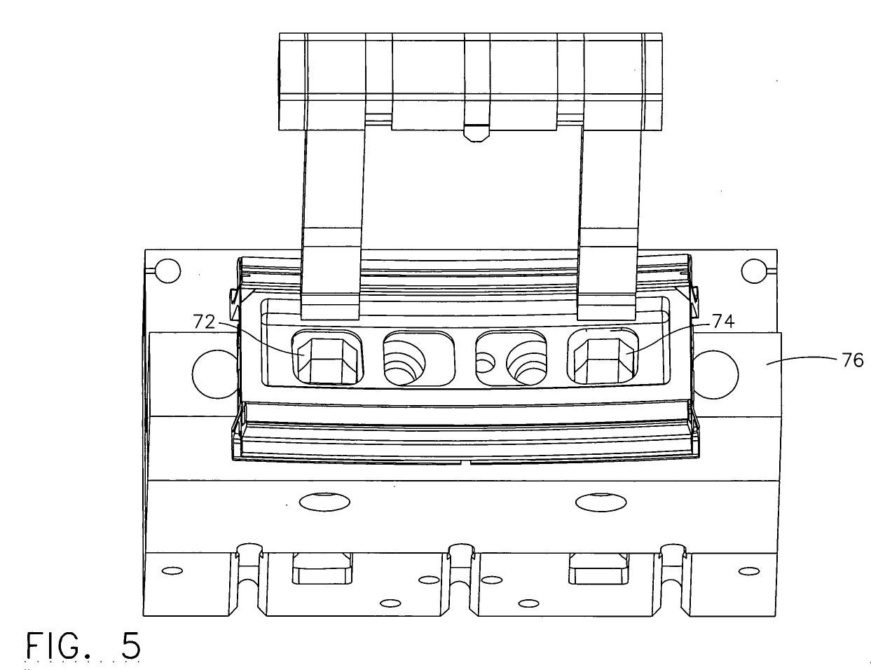

FIG. 4 is a schematic illustration of the work piece 10 in contact with work piece shuttle 50 and lever 84 to align the work piece 10 to ensure that the shuttle six-point datum nest accurately engages the work piece six-point datum positions. Transfer arm 42 has faces 43, 45 each shown at an angle of approximately forty-five degrees to the surface 53, and transfer arm 42 has faces 55, 57 each shown at an angle of approximately forty-five degrees to the surface 59. FIG. 5 schematically illustrates the v-block locators 72, 74 in the support structure 76 that engage the respective angled surfaces 43, 45 and 55, 57 on the transfer arms 42, 44 to lock the work piece 10 against the work piece shuttle 50. The specific angle of surfaces 43, 45 to surface 53 and of surfaces 55, 57 to surface 59 is not critical, so long as the transfer arms 42, 44 are centered with the respective v-block locators 72, 74.

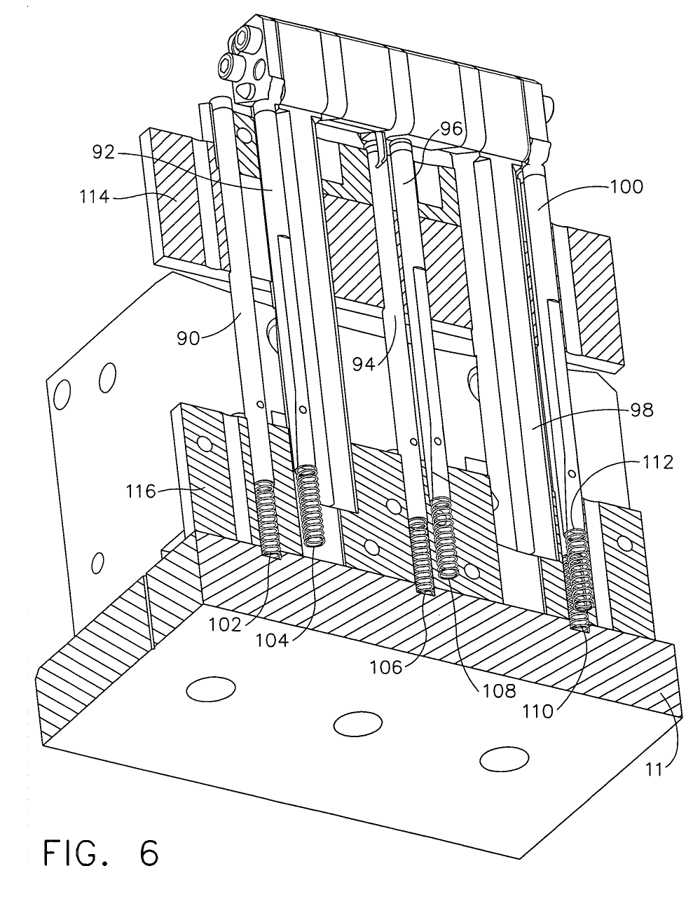

FIG. 6 is a schematic partial illustration of the rod and spring arrangement which secures the work piece datum positions in engagement with the datum contacts on the work piece shuttle 50. Rods 90, 92, 94, 96, 98 and 100 are spring loaded by springs 102, 104, 106, 108, 110 and 112 and held in position in holes in plates 114 and 116. Springs 102, 104, 106, 108, 110 and 112 are placed against plate 118 to bias the rods 90, 92, 94, 96, 98 and 100 into contact with the work piece 10, thereby locking work piece datum positions 20, 22, 24, 26, 28 and 32 into contact with shuttle datum contacts 52, 54, 56, 58, 60 and 64, respectively. The rods 90, 92, 94, 96, 98 and 100 engage the work piece 10 outside and areas to be machined, finished or treated, facilitating the single loading of work piece 10.

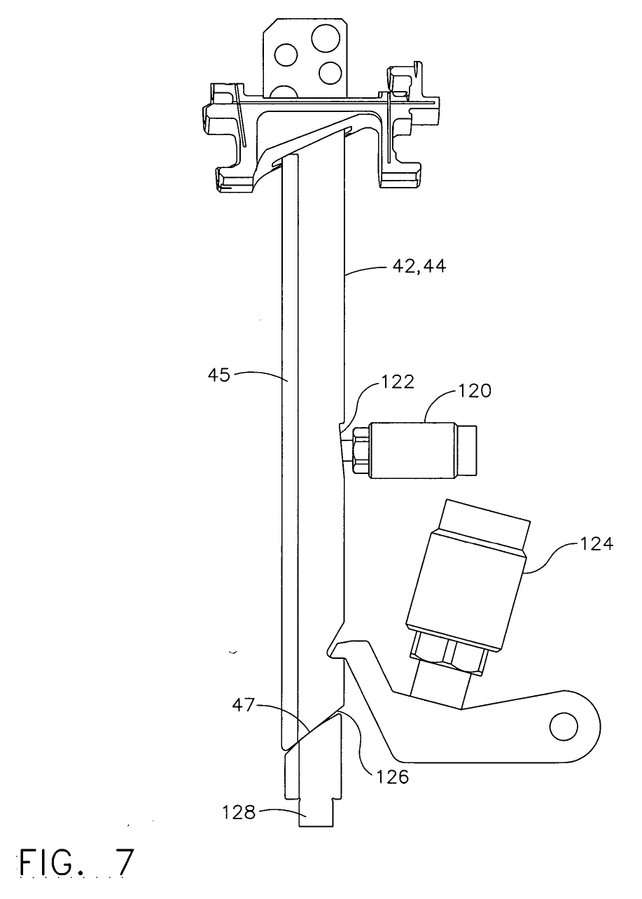

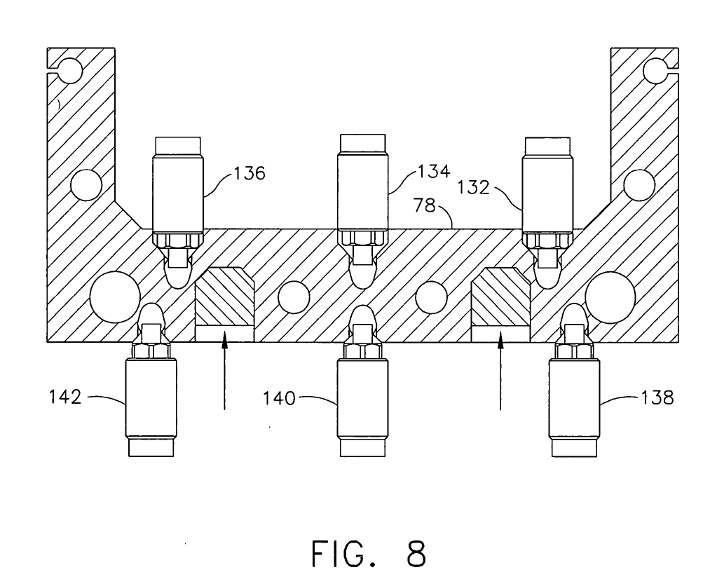

FIG. 7 is a schematic elevation illustration of a work piece holder including hydraulic cylinders 120 which engage notches 122 to lock the shuttle transfer arms 42, 44 in the horizontal position in contact with the v-block locators shown in FIG. 5. Hydraulic cylinders 124 which engage notches 46, 48 to pull transfer arms 42, 44 down. Surface 47 of transfer arm 42 is pulled down to lock surface 47 into contact with curved end surface 126 on peg 128, and surface 49 of transfer arm 44 is pulled into contact with a similar curved end surface of a peg (not shown) to secure shuttle transfer arms 42, 44 in the vertical direction. FIG. 8 is a schematic plan view of a v-block locator member 78. The v-block locator member 78 is moved into engagement with the transfer arms 42, 44 by hydraulic actuators 132, 134, 136, 138, 140 and 142 which move v-block locator member 78 generally perpendicular to the transfer arms 42, 44 to secure work piece 10 against the shuttle 50.

In operation an ID pocket 12 is defined in a work piece 10. The ID pocket and the work piece datum positions within the ID pocket 12 may be secured to a shuttle 50 in a single mounting process, so that it will maintain its exact relationship and transfer the six-point work piece datum to a six point shuttle datum. In the particular process using the apparatus shown in FIGS. 5-8, the work piece 10 is loaded in shuttle 50 so that rods 90, 92, 94, 96, 98 and 100 loaded respectively by springs 102, 104, 106, 108, 110 and 112 locate each of the work piece datum positions 20, 22, 24, 26, 28 and 34 of the six-point datum nest to engage respective datum contacts 52, 54, 56, 58, 60 and 64 of the shuttle six-point datum nest. The transfer arms 42, 44 are drawn into a clamp mechanism and locked against the v-block locators 72, 74. The work piece is now securely locked against the shuttle, and the machining apparatus may perform all grinding, finishing and other metal treatment processes on the surfaces of work piece 10 outside ID pocket 12 without requiring additional positioning and part locating steps. In this process, no sequential reloading of the work piece 10 into separate holding mechanisms is required, so no opportunity is allowed to introduce errors in mounting and securing the work piece 10 to the machining, finishing or other manufacturing apparatus. This represents a significant saving in time and complexity of work piece handling and avoids introduction of errors in multiple work piece handling steps.

While the invention has been described in terms of various specific embodiments, those skilled in the art will recognize that the invention can be practiced with modification within the spirit and scope of the claims.

What is claimed is:

1. A work piece datum transfer apparatus comprising:
a work piece shuttle having a six-point datum nest defining its position in three dimensions corresponding to a work piece six-point datum nest; and
means for locking said work piece shuttle into contact with said work piece shuttle to transfer said datum nest from said work piece to said shuttle.

2. The apparatus of claim 1, wherein:
said work piece includes an ID pocket incorporating said six-point datum nest:
said six-point datum nest comprises three datum points upon said ID pocket defining a plane within said work piece, two datum points within said ID pocket and distinct from said datum points defining said plane and defining a line within said work piece and a single datum point defining an end point of said ID pocket; and
said work piece shuttle six-point datum nest comprises first, second and third datum contacts for engaging said three datum points within said ID pocket, fourth and fifth datum contacts for engaging said two datum points within said ID pocket and a sixth datum contact for engaging said single datum point defining said end point of said ID pocket.

3. A method of transferring a work piece six-point datum nest to a work piece holder comprising the steps of:
identifying six-point datum positions upon a work piece;
defining six-point datum contacts on a work piece holder; and
securing said six-point datum positions upon said work piece into contact with said six-point datum contacts on said work piece holder.

4. The method of claim 3 wherein said step of securing comprises:
placing said work piece into contact with a work piece shuttle having a shuttle six-point datum contacts;
locating the work piece six-point positions in predetermined contact with said six-point datum contacts on said shuttle: and
biasing said shuttle into contact with said work piece with a plurality of spring-loaded work supports.

5. The method of claim 3 wherein:
said step of identifying six-point datum positions upon a work piece comprises defining the six-point datum positions within an ID pocket upon said work piece outside the areas to receive additional machining, finishing or other processing.

6. A datum transfer system comprising:
a work piece mounting shuttle comprising a plurality of datum transfer arms integral with a work piece shuttle having six-point datum contacts located thereon; and
a clamping mechanism for securing a work piece such that a work piece six-point datum is placed into contact with said work piece shuttle six-point datum contacts.
